(19) United States
(12) Patent Application Publication
(10) Pub. No.: US 2014/0073466 A1
(43) Pub. Date: Mar. 13, 2014

(54) PULLEY DEVICE, TURNING MACHINE FITTED WITH SUCH A DEVICE AND METHOD OF MOUNTING SUCH A DEVICE ON A TURNING MACHINE

(71) Applicant: Aktiebolaget SKF, Göteborg (SE)

(72) Inventors: Nicolas Berruet, Artannes sur Indre (FR); Charles Chambonneau, Joué lès Tours (FR); Samuel Viault, Saint Antoine Du Rocher (FR)

(73) Assignee: Aktiebolaget SKF, Göteborg (SE)

(21) Appl. No.: 14/078,448

(22) Filed: Nov. 12, 2013

(30) Foreign Application Priority Data
Nov. 12, 2011 (FR) 12/03027

(51) Int. Cl. F16H 55/36

(52) U.S. Cl. CPC F16H 55/36
USPC 474/94; 29/892.1

(57) ABSTRACT

The invention concerns a pulley device (1) including a pulley (5), a torque transmission means (6) intended to be mounted between the pulley (5) and a transmission shaft (3) of a turning machine, and torque limitation means (16) intended to be mounted between the pulley (5) and the transmission shaft (3). The pulley device also includes at least one bearing (7) intended to be mounted on a non-rotating housing (2) of the turning machine and provided with an inner race (8) with a bore (8b), through which the inner race (8) is intended to be mounted on the housing (2), an outer race (9) and at least one row of rolling elements (10). According to the invention, the pulley device (1) provides axial retention means (17) arranged exclusively radially between the bore (8b) of the inner race (8) and the housing (2).

### CROSS-REFERENCE TO RELATED APPLICATIONS

This application claims priority to French Patent Application 12/03027, filed Nov. 12, 2012, which is herein fully incorporated by reference.

### FIELD OF THE INVENTION

The present invention concerns the field of devices for transmitting torque between a drive pulley device and a shaft driven by the pulley. A torque transmission device of this type may be used in particular in air conditioning compressors such as those mounted in automotive vehicles.

### BACKGROUND OF THE INVENTION

In general, a drive pulley device comprises a pulley linked to a drive belt, at least one bearing between the pulley and a non-rotating housing of a turning machine, and a means for transmitting torque between the pulley and a rotating shaft of the turning machine.

To remedy the harmful effects of acyclisms or sudden decelerations of the motor, which are transmitted to the pulley by a drive belt, it is known for example from JP-B-4015072 to incorporate torque limitation means between the pulley and the shaft.

A damper element can also be provided between the pulley and the transmission shaft in order to filter out acyclisms of the motor and vibrations due to shaft rotation, as described in particular in EP 0 702 167.

However, the addition of such elements to the drive pulley device leads to an increase in the time and cost of production, while introducing tolerances and mounting errors between the various elements and fixing means.

Furthermore it is necessary to provide axial retention means for the pulley device in the case of breakage of the torque limitation means. In fact in this case, the pulley is separated from the drive shaft and can detach from the housing, which could prove dangerous close to a running motor.

The invention is aimed in particular at solving these problems by proposing a new pulley device for a turning machine, in particular for an air conditioning compressor, which is simple and economic to produce and assemble, and guarantees axial retention of the device.

### SUMMARY OF THE INVENTION

To this end, the invention concerns a pulley device for a turning machine comprising a pulley, a torque transmission means intended to be mounted between the pulley and a transmission shaft of a turning machine, and torque limitation means intended to be mounted between the pulley and the transmission shaft. The pulley device also comprises at least one bearing intended to be mounted between the pulley and a non-rotating housing of the turning machine and provided with an outer rotating race, an inner non-rotating race with a bore, through which it is intended to be mounted on the housing, and at least one row of rolling elements.

According to the invention, the device also comprises axial retention means arranged exclusively radially between the bore of the inner race and the housing.

Thanks to the invention, the bearing—and by extension, the pulley—is retained axially on the housing on which it is intended to be mounted. If the pulley separates from the rotating shaft following breakage of the torque limitation means, the pulley is held on the housing via the bearing.

Furthermore the retention means can be integrated directly in the bore of the inner race of the bearing, which facilitates mounting of the pulley device. Thus there are no means of retention to be positioned independently of the bearing.

Finally, the position of the retention means between the inner race of the bearing and the housing to which it is fixed does not extend axially beyond the edges of the inner race and/or the housing, thus optimising the compact construction of the pulley device.

According to advantageous but not obligatory aspects of the invention, such a bearing device can incorporate one or more of the following characteristics in any technically feasible combination:
The rolling elements are balls.
The retention means comprise a groove made circumferentially in the inner cylindrical face of the bore of the inner race, and a ring cooperating with the groove.
The ring is open over an angular portion.
The angular portion of the opening is strictly less than 180° when the ring and the inner race are in the mounted position on the housing.
The ring is made of spring material.
The torque transmission means comprises an axial sleeve intended to be mounted on the rotating shaft of the turning machine and a radial plate extending radially towards the outside of the device from the axial sleeve.
The torque limitation means are provided on the radial plate of the torque transmission means.
The torque transmission means and torque limitation means form one and the same indivisible assembly.
The pulley device comprises a damper element.
The damper element is fixedly secured firstly to the torque transmission means and secondly to the pulley.
The damper element is made of elastic material and is moulded firstly onto the torque transmission means and secondly onto the pulley, thus forming one and the same indivisible assembly.

The invention also concerns a turning machine comprising a non-rotating housing, a transmission shaft and a pulley device according to any of the preceding embodiments.

According to advantageous but not obligatory aspects of the invention, such a turning machine can incorporate one or more of the following characteristics in any technically feasible combination:
The housing comprises a hollow shaft coaxial with the transmission shaft.
The axial retention means are arranged exclusively radially between the bore of the inner race and the outer cylindrical face of the coaxial hollow shaft of the housing.
A groove is made circumferentially on the outer cylindrical face of the coaxial hollow shaft such that the ring cooperates with the groove of the housing and the groove made in the bore of the inner race of the bearing.
The radial thickness of the ring is greater than the depth of the groove made on the coaxial hollow shaft of the housing.
The radial thickness of the ring is greater than the depth of the groove made in the bore of the inner race of the bearing.
The housing is fitted with a shoulder, against which the bearing of the pulley device is mounted, extending radially to the outside of the device from the coaxial hollow shaft and situated at the side of the turning machine.
The coaxial hollow shaft of the housing is provided with a free end, on the opposite side to the turning machine, which is conical on its outer periphery, forming a mounting ramp for a support ring.

The present invention also concerns a method of mounting a pulley device on a turning machine, this method comprising at least the following successive steps:

(a) A pulley and torque transmission means and torque limitation means are fixedly assembled.

(b) Axial retention means are mounted in a bore of an inner race of a bearing.

(c) The bearing is mounted in the pulley and fixedly secured.

(d) The assembly comprising the bearing, the axial retention means, the pulley, the torque transmission means and the torque limitation means is mounted on the turning machine, in particular:
(d.1) the torque transmission means are fixedly assembled on the transmission shaft of the turning machine, and
(d.2) the bearing is mounted on a housing such that the axial retention means cooperate with the housing.

Advantageously, during the first step a damper element is moulded onto the pulley and the torque transmission means and the torque limitation means.

According to an embodiment of the method, during the second step a ring is mounted in a groove made in the bore of the inner race of a bearing, and during the final step, the ring cooperates with a groove made on the housing.

According to another embodiment of the method, during the final step, the ring slides over a conical free end of a coaxial hollow shaft of the housing before being inserted in the groove made on the housing.

Thanks to the invention, the bearing, the axial retention means, the pulley, the torque transmission means and the torque limitation means form an integral assembly and can be transported from the production sites to an assembly site of a turning machine, thus simplifying the component management, reducing the packaging costs and facilitating final assembly on the machine.

Furthermore the retention means are mounted in a simple manner without the need for additional tooling or a specific mechanical or geometric design of the pulley, the torque transmission means and the torque limitation means or the damper element.

### BRIEF DESCRIPTION OF THE FIGURES

The invention will be better understood and other advantages thereof will appear more clearly in the light of the description below of one embodiment of a pulley device according to its principle, given merely as an example and with reference to the attached drawings in which:

FIG. 1 is a front view of a pulley device according to the invention;

FIG. 2 is a view in section II-II of the pulley device according to FIG. 1, mounted on a shaft of an air conditioning unit for an automotive vehicle;

FIG. 3 is a cross section view of a bearing fitted to the pulley device according to the invention;

FIG. 4 is a cross section view of a housing of an air conditioning unit for an automotive vehicle; and

FIG. 5 is a top view of a support ring fitted to the pulley device according to the invention.

### DETAILED DESCRIPTION OF THE INVENTION

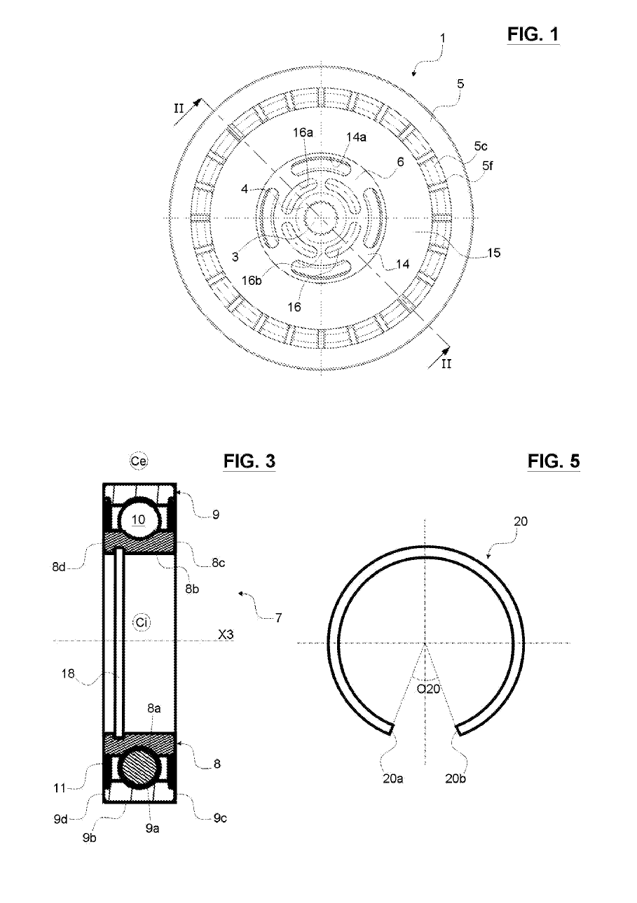

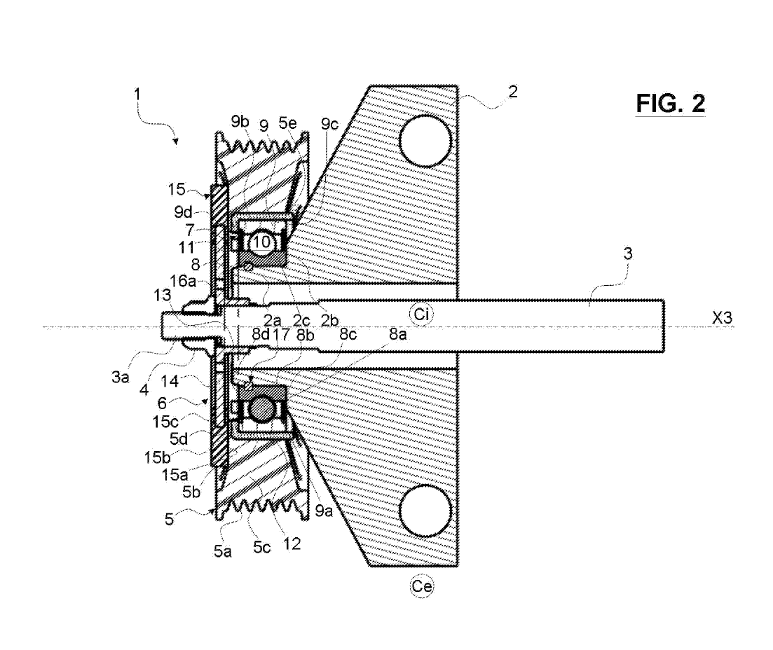

According to FIGS. 1 and 2, a pulley device 1 is mounted in a compressor comprising a non-rotating housing 2 and a transmission shaft 3 with rotation axis X3. The transmission shaft 3 comprises a threaded portion 3a intended to cooperate with a nut 4. The housing 2 comprises a hollow shaft 2a coaxial with the transmission shaft 3.

Then, to facilitate spatial referencing of the pulley device, an inside Ci is defined corresponding to the main axis X3, and an outside Ce opposite the axis X3 through the pulley device 1.

Furthermore the adjectives “axial” and “radial” and the adverb “axially” are defined in relation to the central axis X3 of the pulley device 1. Thus an axial portion or part is parallel to axis X3, while a radial portion or part is perpendicular to this axis and surrounds it. A surface is called axial when it extends perpendicular to axis X3 and radial when it extends perpendicular to a normal to this axis. For example a radial portion is provided with an inner face oriented towards the inside Ci of the pulley device 1, i.e. towards axis X3, and an outer radial face oriented in the opposite direction to this axis, towards the outside Ci of the pulley device 1.

The pulley device 1 comprises a pulley 5, a torque transmission means 6 and a rolling bearing 7.

The pulley 5 comprises an outer axial portion 5a with an outer face intended to cooperate with a belt or chain (not shown), an inner axial portion 5b, and a radial, annular, intermediate portion 5c linking the outer and inner portions 5a, 5b. The outer and inner portions 5a and 5b are coaxial to the rotation axis X3. The outer axial portion 5a is fitted with ribs defining between them grooves which receive the corresponding ribs of the V-belts or a single belt. The inner axial portion 5b comprises a radial edge 5d directed radially towards the inside Ci of the pulley device 1 and a bore 5e in which the rolling bearing 7 is housed. Stiffening ribs 5f are also provided between the outer and inner axial portions 5a, 5b and are joined on the intermediate portion 5c.

The torque transmission means 6 comprises an axial sleeve 13, a radial plate 14 extending radially towards the outside Ce from the axial sleeve 13, and a damper element 15. The radial plate 14 and the axial sleeve 13 form a single part produced by deep-drawing from a metal sheet. The axial sleeve 13 is fixed on the transmission shaft 3 by the nut 4. The radial plate 14 is generally disc-shaped and is provided with torque limitation means 16. The radial plate 14 also comprises a series of oblong through-holes 14a, for example four in number, distributed circumferentially and angularly equidistant from each other, in order to allow the insertion of a mounting tool (not shown).

The damper element 15 is arranged between the pulley 5 and the radial plate 14 to filter the acyclisms of the motor and the vibrations of the transmission shaft 3. The damper element 15 is generally crown-shaped and comprises two radial lateral walls 15a, 15b and an inner housing 15c between the two radial lateral walls 15a, 15b in its thickness, opening radially into a bore (not referenced) of diameter greater than the diameter of the transmission shaft 3. The inner housing 15c corresponds in shape to the radial plate 14. One radial lateral wall 15a rests axially against a radial lateral surface of the pulley 5, and the second radial lateral wall 15b is arranged towards the outside of the pulley device 1. The damper element 15 is made of elastic material, for example thermoplastic elastomer (TPE) and is moulded firstly onto the radial plate 14 and secondly onto the pulley 5. The assembly consisting of the torque transmission means 6 with the damper element 15, the torque limiter 14 and the pulley 5 thus forms one and the same indivisible assembly.

The torque limitation means 16 comprise a series of oblong through-holes 16a, for example four in number, angularly equidistant from each other and centred on the same circle. Two adjacent through-holes 16a are spaced circumferentially by a portion 16b which is intended to break when the torque transmitted by the pulley 5 to the transmission shaft 3 exceeds a threshold value, for example 50 Nm.

The rolling bearing 7 comprises an inner race 8, an outer race 9, a row of rolling elements 10—here balls—arranged between the bearing raceways 8a, 9a of races 8, 9 respectively, and two sealing gaskets 11 which are symmetrical in relation to a radial plane passing through the centre of the rolling elements 10.

The outer race 9 has a bore in which the toroidal raceway 9a for the rolling elements 10, grooves which hold the sealing gaskets 11, an outer axial surface of revolution 9b which is held in the bore 5e of the pulley 5 via an L-shaped annular flange 12, and two radial lateral surfaces 9c, 9d are arranged. One of the lateral surfaces 9d rests axially against the radial rim 5d of the pulley 5, via a radial rim of the flange 12. The annular flange 12 comprises an axial portion (not referenced) intended to be folded against the other lateral portion 9c in order to retain axially the outer race 9 of the rolling bearing 7.

The inner race 8 comprises an axial outer surface of revolution in which the toroidal raceway 8a for the rolling elements 10, a bore 8b in contact with the outer cylindrical face 2c of the hollow shaft 2a, and two radial lateral surfaces 8c, 8d are arranged. One of the lateral surfaces 8c is in axial contact with a shoulder 2b extending radially towards the outside Ce of the pulley device 1 from the hollow shaft 2a and is situated on the side of the compressor. The other lateral surface 8d is free.

In accordance with the invention, axial retention means 17 are arranged radially between the bore 8b of the inner race 8 of the rolling bearing 7 and the outer face 2c of the hollow shaft 2a of the housing 2 on which it is mounted.

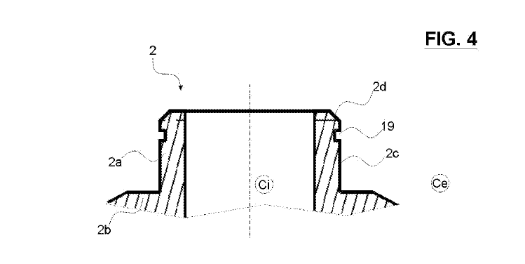

As shown in FIGS. 2 to 5, the axial retention means 17 consist of a groove 18 made circumferentially on the bore 8b of the inner race 8 of the rolling bearing 7, a groove 19 made circumferentially on the outer face 2c of the hollow shaft 2a of the housing 2, and a support ring 20 cooperating with the grooves. The grooves 18 and 19 of the inner race 8 and of the hollow shaft 2a respectively are positioned such that they are at the same axial level, together forming an annular passage which is closed when the inner race 8 and the housing 2 are assembled.

The support ring 20 is made of spring material, is annular in form and is provided with an opening between two ends 20a and 20b. The angular portion O20 defined between the two ends 20a, 20b is strictly less than 180°, for example equal to 30°. This ensures that the ring 20 remains held in the groove 18 of the inner race 8 between two steps of the mounting method, without risk of the ring falling out. The ring 20 is mounted in the groove 18 by deformation of the ring 20 thanks to the opening and the elastic properties of the steel spring from which it is made.

To facilitate mounting of the support ring 20 in the groove 19 of the hollow shaft 2a, the outer face 2c of the free end 2d of the hollow shaft 2a situated opposite the shoulder 2b comprises a conical shape forming a mounting ramp for the support ring 20. The ring 20 is mounted in the groove 19 by deformation of the ring 20 thanks to the opening and the elastic properties of the spring steel from which it is made.

Once mounted in the annular passage formed by the two grooves 18, 19, the ring 20 recovers its free shape. The support ring 20 has a radial thickness strictly greater than the depth of the groove 18 and strictly greater than the depth of the groove 19.

In the case of breakage of the torque limitation means 16, the pulley 5 continues to be driven by the belt but no longer transmits torque to the transmission shaft 3. The support ring 20 can then return to rest axially against the inner lateral walls of the grooves 18, 19, thus preventing the axial displacement of the inner race 8, and by extension of the rolling bearing 7 and the assembly formed by the pulley 5, the torque transmission means 6 and the torque limitation means 16, and the damper element 15, in relation to the housing 2 of the compressor.

The present invention also concerns a method for mounting a pulley device on a turning machine, this method comprising at least the following successive steps:

(a) A pulley 5, torque transmission means 6 and torque limitation means 16 and a damper element 15 are fixedly assembled, in particular by moulding the damper element 15 firstly onto the torque transmission means 6 and the torque limitation means 16 and secondly onto the pulley 5.

(b) A support ring 20 is mounted in a groove 18 made in the bore 8b of the inner race 8 of a bearing 7.

(c) The bearing 7 is mounted in the pulley 5 and fixedly secured.

(d) The assembly comprising the bearing 7, the ring 20, the pulley 5, the torque transmission means 6 and the torque limitation means 16, and the damper element 15, is mounted on the turning machine, in particular:
(d.1) the torque transmission means 6 are fixedly assembled on a transmission shaft 3 of the turning machine, and
(d.2) the bearing 7 is mounted on a non-rotating housing 2 of the turning machine such that the ring 20 cooperates with a groove 19 made on the outer face 2c of the housing 2.

According to this final step of the method, the ring 20 slides over a conical free end of a hollow shaft 2a of the housing 2 before being inserted in the groove 19 made on the housing 2.

The invention is not limited to the embodiment described and can be varied in a number of ways.

Thanks to the invention, a pulley device can be produced and assembled on a turning machine, such as a compressor, in a simple, economic and easy manner, without risk of separation in the case of breakage of the torque limiter.

1. A pulley device (1) comprising:
a pulley (5),
a torque transmission means (6) intended to be mounted between the pulley (5) and a transmission shaft (3) of a turning machine,
torque limitation means (16) intended to be mounted between the pulley (5) and the transmission shaft (3), and
at least one bearing (7) intended to be mounted on a non-rotating housing (2) of the turning machine and provided with an inner race (8) with a bore (8b), through which the inner race (8) is intended to be mounted on the housing (2), an outer race (9) and at least one row of rolling elements (10), and
axial retention means (17) arranged exclusively radially between the bore (8b) of the inner race (8) and the housing (2).

2. The pulley device (1) according to claim 1, wherein a damper element (15) made of elastic material is moulded firstly onto the torque transmission means (6) and secondly onto the pulley (5).

3. The pulley device (1) according to claim 2, wherein the axial retention means (17) provides a groove (18) made circumferentially in the bore (8b) of the inner race (8), and a support ring (20) cooperating with the groove (18).

4. The pulley device (1) according to claim 3, wherein the support ring (20) is made of spring material and includes an opening between two ends (20a, 20b) of angular portion (O20) strictly less than 180°.

5. A turning machine comprising:
a non-rotating housing (2) fitted with a hollow shaft (2a) coaxial with a transmission shaft (3), and
a pulley device (1) including;
a pulley (5),
a torque transmission means (6) intended to be mounted between the pulley (5) and a transmission shaft (3) of a turning machine,
torque limitation means (16) intended to be mounted between the pulley (5) and the transmission shaft (3), and
at least one bearing (7) intended to be mounted on a non-rotating housing (2) of the turning machine and provided with an inner race (8) with a bore (8b), through which the inner race (8) is intended to be mounted on the housing (2), an outer race (9) and at least one row of rolling elements (10), and
axial retention means (17) arranged exclusively radially between the bore (8b) of the inner race (8) and the housing (2).

6. The turning machine according to claim 5, wherein axial retention means (17) are arranged exclusively radially between the bore (8b) of the inner race (8) of the bearing (7) of the pulley device (1) and an outer cylindrical face (2c) of the hollow shaft (2a) of the housing (2).

7. The turning machine according to claim 6, wherein a groove (19) is made circumferentially on the outer cylindrical face (2c) of the hollow shaft (2a) such that a support ring (20) cooperates with the groove (19) of the housing (2) and the groove (18) made in the bore (8b) of the inner race (8) of the bearing (7).

8. The turning machine according to claim 7, wherein the hollow shaft (2a) provides a free end (2d) which is conical on its outer periphery, forming a mounting ramp for the support ring (20).

9. The turning machine according to claim 8, wherein the radial thickness of the support ring (20) is greater than the depth of the groove (19) made on the hollow shaft (2a) of the housing (2) and the depth of the groove (18) made in the bore (8b) of the inner race (8) of the bearing (7).

10. A method of mounting a pulley device (1) on a turning machine, comprising the following steps:
(a) fixedly assembling a pulley (5) and torque transmission means (6) and torque limitation means (16) together,
(b) mounting axial retention means (17) in a bore (8b) of an inner race (8) of a bearing (7),
(c) mounting the bearing (7) in the pulley (5) and fixedly securing the bearing and pulley together,
(d) mounting the bearing (7), the axial retention means (17), the pulley (5), the torque transmission means (6) and the torque limitation means (16) on the turning machine, wherein
(d.1) fixedly assembling the torque transmission means (6) on a transmission shaft (3) of the turning machine, and
(d.2) mounting the bearing (7) on a housing (2) of the turning machine such that the axial retention means (17) cooperate with the housing (2).

11. The method according to claim 10, wherein during the first step, a damper element (15) is moulded onto the pulley (5) and the torque transmission means (6) and the torque limitation means (16).

12. The method according to claim 11, wherein
during the second step, a support ring (20) is mounted in a groove (18) made in the bore (8b) of the inner race (8) of a bearing (7), and
during the final step, the support ring (20) cooperates with a groove (19) made on the housing (2).

13. The method according to claim 12, wherein during the final step, the support ring (20) slides over a conical free end (2d) of a hollow shaft (2a) of the housing before being inserted in the groove (19) made on the housing (2).
